(19) United States
(12) Patent Application Publication
(10) Pub. No.: US 2016/0352017 A1
(43) Pub. Date: Dec. 1, 2016

(54) TUNABLE ANTENNA

(71) Applicant: Kyocera Corporation, Kyoto-shi (JP)

(72) Inventors: Mitsuhiro NISHIZONO, Tokyo (JP); Daisuke TOGASHI, Yokohama-shi (JP); Kouhei SUGAWARA, Yokohama-shi (JP)

(21) Appl. No.: 15/163,671

(22) Filed: May 25, 2016

(30) Foreign Application Priority Data
May 26, 2015 (JP) 2015-106461

(51) Int. Cl. H01Q 9/04

(52) U.S. Cl. CPC H01Q 9/0442

(57) ABSTRACT

A tunable antenna includes an antenna element having a feed point at one end thereof, a feed line being connected to the feed point, and a switcher that switches the resonance frequency of the antenna element. The switcher is connected to the antenna element at a position that is at a distance other than (λₘ/4)×n from the one end towards another end of the antenna element, where λₘ represents the wavelength corresponding to any resonance frequency of the antenna element, and n is a positive, odd number.

### CROSS REFERENCE TO RELATED APPLICATION

This application claims priority to and the benefit of Japanese Patent Application No. 2015-106461 (filed on May 26, 2015), the entire contents of which are incorporated herein by reference.

### TECHNICAL FIELD

This disclosure relates to a tunable antenna.

### BACKGROUND

In recent years, the frequency band that an antenna needs to cover has expanded as a result of faster, higher-capacity radio communication, in particular on mobile terminals and the like. Therefore, in order to implement an antenna that supports numerous frequency bands, a tunable antenna that can switch the resonance frequency has been developed by providing electronic components, such as switches and tunable capacitors, inside a matching circuit connected between the antenna element and the feed.

Tunable antennas that vary the actual antenna element length by providing electronic components such as switches and tunable capacitors in the antenna element have also been proposed. With such a tunable antenna, by changing the reactance component of the antenna element, the resonance frequency can be switched dynamically as compared to a structure in which electronic components are disposed inside the matching circuit.

### SUMMARY

A tunable antenna according to this disclosure includes:

an antenna element including a feed point at one end thereof, a feed line being connected to the feed point; and

a switcher configured to switch a resonance frequency of the antenna element;

such that the switcher is connected to the antenna element at a position that is at a distance other than (λₘ/4)×n from the one end towards another end of the antenna element, where λₘ represents a wavelength corresponding to any resonance frequency of the antenna element, and n is a positive, odd number.

A tunable antenna according to this disclosure includes:

an antenna element including a feed point at one end thereof, a feed line being connected to the feed point;

a switcher configured to switch a resonance frequency of the antenna element; and

a phase rotator connected between the antenna element and the switcher and configured to shift a phase of voltage applied to the switcher.

A tunable antenna according to this disclosure includes:

an antenna element including a feed point at one end thereof, a feed line being connected to the feed point;

a switcher configured to switch a resonance frequency of the antenna element; and

a frequency selector connected between the antenna element and the switcher and configured to allow passage of a signal at a predetermined frequency.

A tunable antenna according to this disclosure includes:

an antenna element including a feed point at one end thereof, a feed line being connected to the feed point;

a switcher configured to switch a resonance frequency of the antenna element; and

an impedance adjustor connected between the antenna element and the switcher and configured to lower an input impedance of the switcher.

### BRIEF DESCRIPTION OF THE DRAWINGS

In the accompanying drawings:

FIG. 1 schematically illustrates the structure of a tunable antenna according to Embodiment 1;

FIGS. 2A and 2B conceptually illustrate the voltage distribution on the antenna element in accordance with the wavelength of a standing wave;

FIG. 3 schematically illustrates the structure of a tunable antenna according to a modification to Embodiment 1;

FIG. 4 schematically illustrates the structure of a tunable antenna according to Embodiment 2;

FIGS. 5A and 5B schematically illustrate the structure of a phase rotator in the tunable antenna according to Embodiment 2;

FIG. 6 schematically illustrates the structure of a tunable antenna according to Embodiment 3;

FIGS. 7A and 7B schematically illustrate the structure of a frequency selector in the tunable antenna according to Embodiment 3;

FIG. 8 schematically illustrates the structure of a tunable antenna according to Embodiment 4; and

FIGS. 9A and 9B schematically illustrate the structure of an impedance adjustor in the tunable antenna according to Embodiment 4.

### DETAILED DESCRIPTION

With reference to the drawings, the following describes embodiments of this disclosure in detail.

Since a standing wave occurs in an antenna element, there exist locations where the voltage is maximized and minimized. Accordingly, in a tunable antenna in which the antenna element length is made variable by providing electronic components in the antenna element, a high voltage might be applied to the electronic components if the electronic components are disposed at a position where the voltage is high.

Therefore, as a tunable antenna in which the antenna element length is made variable by providing electronic components in the antenna element, it would be helpful to provide a tunable antenna that allows a reduction in application of high voltage to the electronic components.

### Embodiment 1

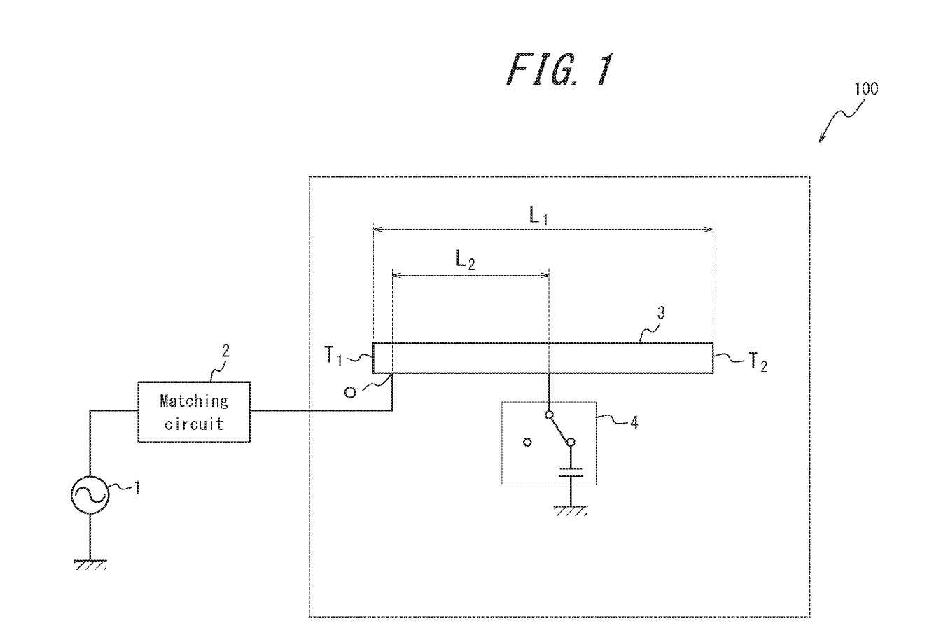

FIG. 1 schematically illustrates the structure of a tunable antenna 100 according to Embodiment 1. As illustrated in FIG. 1, the tunable antenna 100 includes an antenna element 3 and a switcher 4. A feed 1, a matching circuit 2, and the antenna element 3 are connected in this order via a feed line, and the switcher 4 is connected to the antenna element 3. The connection point between the antenna element 3 and the feed line is referred to as a feed point O. The tunable antenna 100, feed 1, and matching circuit 2 constitute a portion of an electronic device (not illustrated).

The feed 1 feeds a signal for generating a radio wave of a predetermined frequency to the matching circuit 2. The feeding method of the feed 1 is current feeding, configured so that the current is maximized and the voltage is minimized at the feed point O.

The matching circuit 2 adjusts the impedance so as to reduce the energy loss between the feed 1 and the antenna element 3. By adjusting the impedance of the matching circuit 2, the frequency (resonance frequency or matching frequency) of the radio wave transmitted and received via the antenna element 3 can be adjusted to some degree. The matching circuit 2 is, for example, mounted on a printed board such as a Printed Circuit Board (PCB) or a Flexible Printed Circuit (FPC) and is connected to the antenna element 3.

The antenna element 3 is, for example, a monopole antenna that includes the feed point O where the feed line is connected near one end T₁ of the antenna element 3. The antenna element 3 may be configured with sheet metal or may be an element printed on a case. The length L₁ from one end T₁ to the other end T₂ of the antenna element 3 is equivalent to a positive, odd multiple of one fourth the length (λ₁/4) of the fundamental wavelength λ₁ corresponding to a certain fundamental frequency f1.

The switcher 4 is an electronic component for switching the resonance frequency by switching the reactance component of the antenna element 3 and is configured with a switch, a variable element such as a tunable capacitor, or a combination thereof. The switcher 4 is connected at a position that is a distance L₂ from one end T₁ of the antenna element 3 towards the other end T₂.

Details on the distance L₂ are provided below. The resonance frequency is assumed to be switched for example among the 700 MHz band, 800 MHz band, and 900 MHz band in the Low Band but may also be switched to the 2 GHz band in the Mid Band, the 2.5 GHz band in the High Band, and the like. The switcher 4 is, for example, mounted on a printed board such as a PCB or FPC and is connected to the antenna element 3.

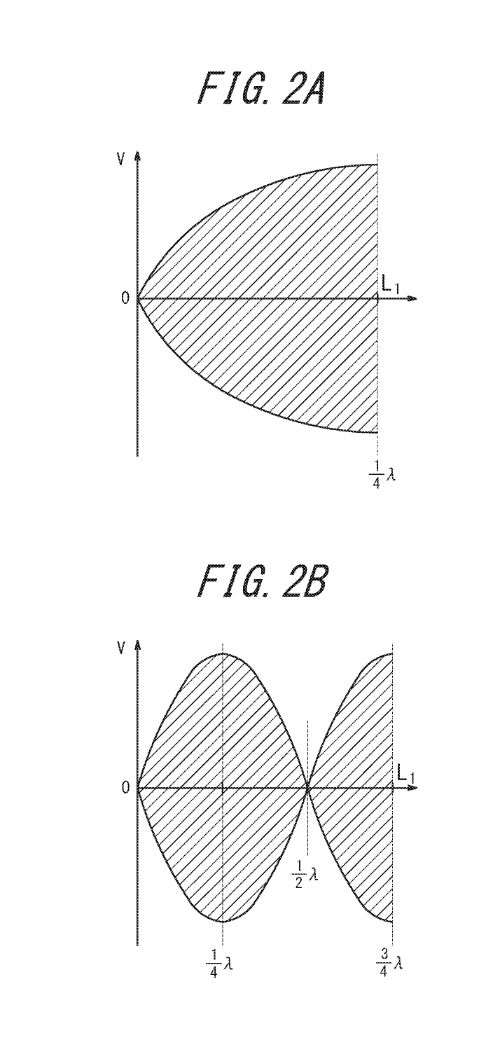

FIGS. 2A and 2B conceptually illustrate the voltage distribution on the antenna element 3 in accordance with the relationship between the length L₁ of the antenna element 3 and the fundamental wavelength λ₁. Specifically, FIGS. 2A and 2B respectively illustrate the voltage distribution on the antenna element 3 when L₁=λ₁/4 and when L₁=3λ₁/4. In these figures, the horizontal axis represents the distance from one end T₁ (0) of the antenna element 3 towards the other end T₂, and the vertical axis represents the voltage V. As illustrated in FIGS. 2A and 2B, when L₁=λ₁/4, the voltage distribution is a standing wave in which a node occurs at one end T₁ (0), which is the feed point O, and an antinode occurs at the other end T₂ (λ₁/4), whereas when L₁=3λ₁/4, the voltage distribution is a standing wave in which nodes occur at one end T₁ (0), which is the feed point O, and at λ₁/2, and antinodes occur at λ₁/4 and at the other end T₂ (3λ₁/4). In this way, the voltage on the antenna element 3 becomes a standing wave in which an antinode occurs when the distance from one end T₁ to the other end T₂ is (λ₁/4)×n (where n is a positive, odd number; the same holds below).

Maximum voltage occurs at locations where the voltage distribution on the antenna element 3 is the antinode of a standing wave. Therefore, in this embodiment, the switcher 4 is connected at a position other than the antinodes of the voltage distribution on the antenna element 3. In other words, the distance L₂ from one end T₁ of the antenna element 3 towards the other end T₂, i.e. the position where the switcher 4 is connected, is a value other than (λ₁/4)×n. The voltage on the antenna element 3 can take the form of a standing wave with an antinode when the distance from one end T₁ towards the other end T₂ is (λ₂/4)×n or (λ₃/4)×n, where the resonance frequencies that can be switched to by the switcher 4 are f2 and f3 and the corresponding wavelengths are λ₂ and λ₃. Accordingly, the distance L₂ is a value other than (λₘ/4)×n (where m is 1, 2, or 3). The resonance frequencies that can be switched to by the switcher 4 are not limited to two types. The number of types may be one, or may be three or more.

The distance L₂ is preferably less than λₘᵢₙ/4, where λₘᵢₙ represents the smallest wavelength among the wavelengths corresponding to all of the resonance frequencies of the antenna element 3. In this way, degradation in characteristics or destruction of the electronic components constituting the switcher 4 can more reliably be prevented at all of the desired frequencies.

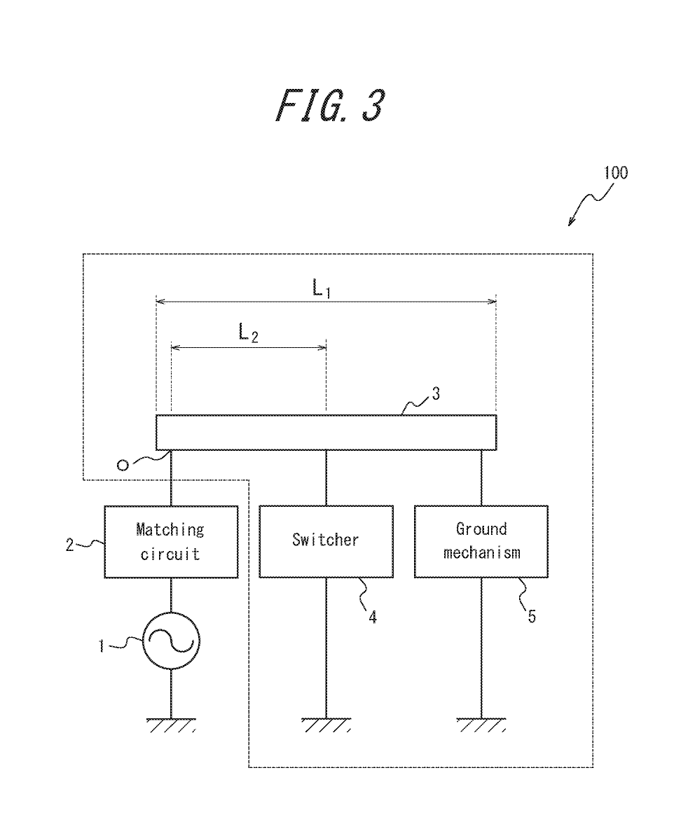

When it is difficult to connect the switcher 4 at the desired position due to a mechanistic limitation or the like, a ground mechanism 5 may be connected to the other end T₂, as illustrated in FIG. 3. In this way, the amplitude of the voltage can be adjusted, thus easily allowing the distance L₂ to be set to less than λₘᵢₙ/4. The ground mechanism 5 may be directly connected to the GND or may be connected to the GND via an inductor, capacitor, resistor, or the like.

When L₁=λₘₐₓ/4, where the largest wavelength among the wavelengths λ₁, λ₂, and λ₃ is λₘₐₓ, the ground mechanism 5 is preferably disposed at a position that is λₘₐₓ/8 or less and less than λₘᵢₙ/4 from one end T₁ of the antenna element 3 towards the other end T₂.

In this way, in the tunable antenna 100 according to this embodiment, the switcher 4 is connected to the antenna element 3 at a position that is at a distance other than (λₘ/4)×n (where λₘ represents the wavelength corresponding to any resonance frequency of the antenna element 3, and n is a positive, odd number) from one end T₁ of the antenna element 3 towards the other end T₂. In this way, a high voltage can be prevented from being applied to the switcher 4, thereby preventing degradation in characteristics or destruction of the electronic components constituting the switcher 4. Accordingly, a compact, high-performance tunable antenna 100 can be obtained.

### Embodiment 2

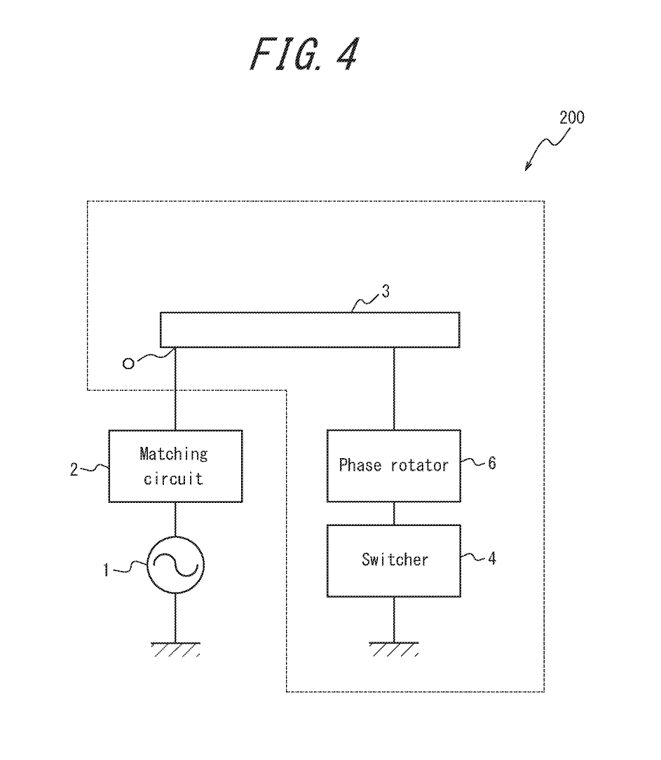

FIG. 4 schematically illustrates the structure of a tunable antenna 200 according to Embodiment 2. As illustrated in FIG. 4, the tunable antenna 200 has the same structure as that of the tunable antenna 100 in Embodiment 1, except that the distance L₂ is not limited, i.e. the position at which the switcher 4 is connected to the antenna element 3 is not limited, and that a phase rotator 6 is further included between the antenna element 3 and the switcher 4. A description of the same structure is therefore omitted.

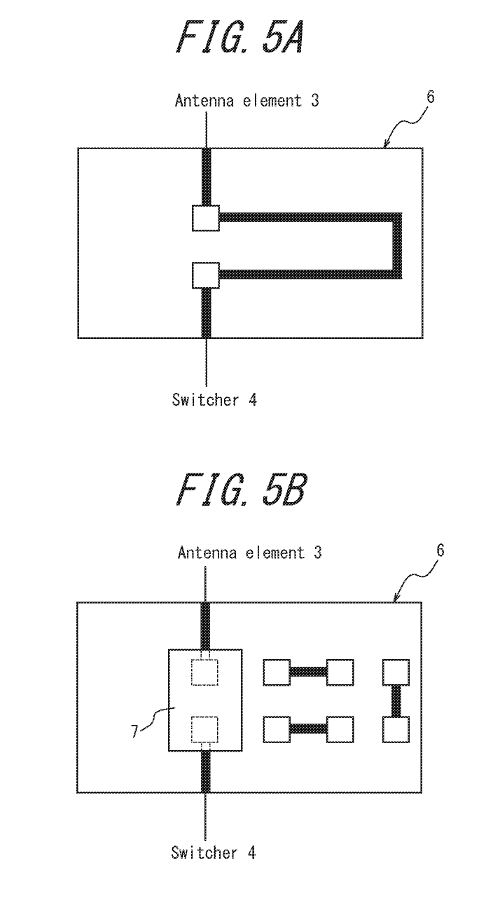

For example as illustrated in FIG. 5A, the phase rotator 6 may be configured by a pattern printed on a printed board, such as a PCB or FPC. The phase rotator 6 may also be formed by a matching circuit. The matching circuit may have a structure similar to that of the matching circuit 2. The value of ω is preferably π/2×n, where ω is the phase of voltage shifted by the phase rotator 6. As a result, even if the location where the switcher 4 is connected to the antenna element 3 via the phase rotator 6 is a location where an antinode of the standing wave of the voltage distribution occurs, the phase of voltage is shifted by the phase rotator 6 to a location other than the antinode of the standing wave. Therefore, a high voltage can be prevented from being applied to the switcher 4.

As illustrated in FIG. 5B, by further dividing up the pattern of the phase rotator 6 and connecting at a 0Ω jumper 7, the pattern length can easily be adjusted, preventing formation of an unnecessary stub. Furthermore, an inductor or capacitor may be used instead of the 0Ω jumper 7.

In this way, according to this embodiment, the tunable antenna 200 includes the phase rotator 6 between the antenna element 3 and the switcher 4, so that even if the switcher 4 is connected at a position on the antenna element 3 at which an antinode of a standing wave occurs in the voltage distribution, the phase of voltage is shifted by the addition of a path due to the phase rotator 6 connected therebetween. Therefore, a high voltage can be prevented from being applied to the switcher 4, thereby preventing degradation in characteristics or destruction of the electronic components constituting the switcher 4. Accordingly, a compact, high-performance tunable antenna 200 can be obtained.

### Embodiment 3

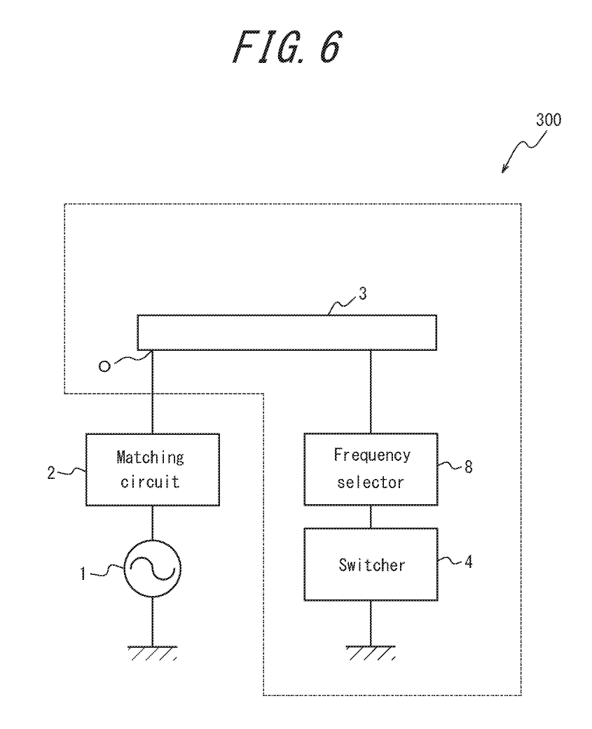

FIG. 6 schematically illustrates the structure of a tunable antenna 300 according to Embodiment 3. As illustrated in FIG. 6, the tunable antenna 300 has the same structure as that of the tunable antenna 200 in Embodiment 2, except that a frequency selector 8 is further included between the antenna element 3 and the switcher 4 instead of the phase rotator 6. A description of the same structure is therefore omitted.

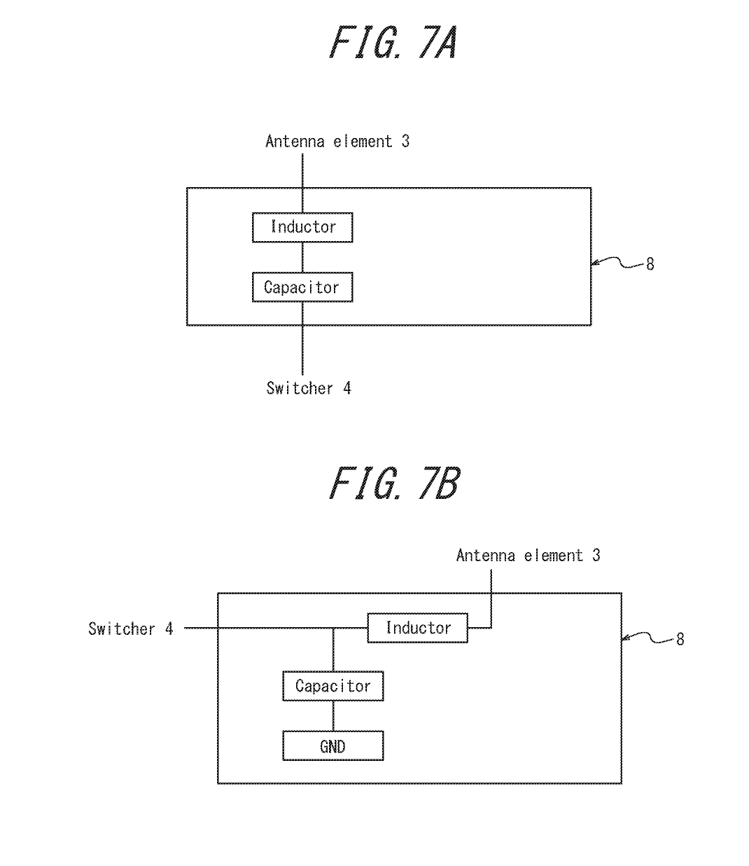

The frequency selector 8 has the function of allowing passage of a signal in a predetermined frequency band while blocking signals in other frequency bands. In this way, a high voltage can be prevented from being applied to the switcher 4 in an undesired frequency band. As illustrated in FIG. 7A, the frequency selector 8 may, for example, use series resonance formed by an inductor and a capacitor.

As illustrated in FIG. 7B, the frequency selector 8 may also be a low pass filter formed by a combination of elements. The frequency selector 8 may also have any other structure, such as a parallel resonance circuit or a high pass filter, as long as similar effects are obtained. Even when using the frequency selector 8, the effect of switching is not experienced and characteristics can be maintained for example in a frequency band unrelated to the frequency band switched to by the switcher 4.

The frequency selector 8 can also be used to achieve the function of a phase rotator. In other words, the phase of voltage can be shifted by the path that is added on as a result of including the frequency selector 8. As a result, application of a high voltage to the switcher 4 can be prevented.

In this way, according to this embodiment, the tunable antenna 300 includes the frequency selector 8 between the antenna element 3 and the switcher 4, thereby allowing passage of a signal in a desired frequency band while blocking signals in other frequency bands. Therefore, a high voltage can be prevented from being applied to the switcher 4 in an undesired frequency band, thereby preventing degradation in characteristics or destruction of the electronic components constituting the switcher 4. Accordingly, a compact, high-performance tunable antenna 300 can be obtained.

### Embodiment 4

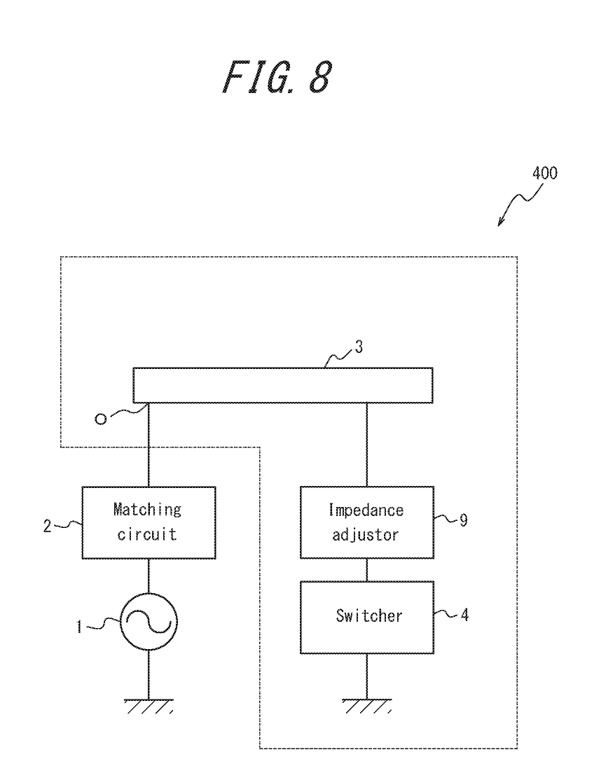

FIG. 8 schematically illustrates the structure of a tunable antenna 400 according to Embodiment 4. As illustrated in FIG. 8, the tunable antenna 400 has the same structure as that of the tunable antenna 200 in Embodiment 2, except that an impedance adjuster 9 is further included between the antenna element 3 and the switcher 4 instead of the phase rotator 6. A description of the same structure is therefore omitted.

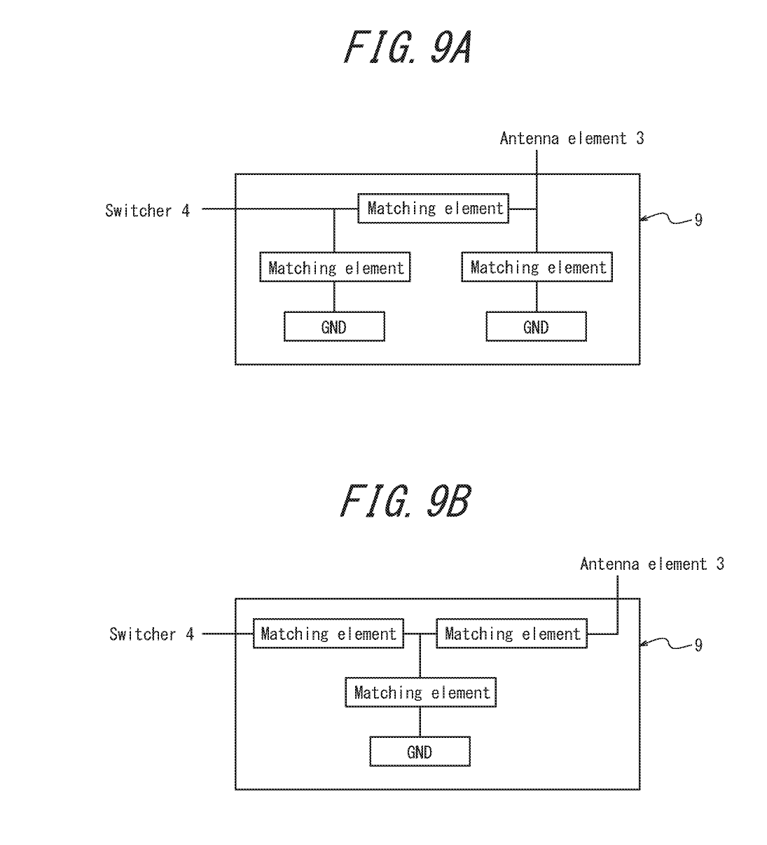

The impedance adjuster 9 is for adjusting the input impedance of the switcher 4 and may, for example, be formed by matching elements connected as illustrated in FIG. 9A (π-shaped) or connected as illustrated in FIG. 9B (T-shaped). The impedance adjuster 9 may also have any other structure as long as similar effects are obtained.

The voltage V applied to the switcher 4 satisfies the following equation, where R is impedance and P is power.

V²=2RP Equation 1

As can be understood from Equation 1, the applied voltage is proportional to the square root of the impedance. Accordingly, by connecting the impedance adjuster 9 between the antenna element 3 and the switcher 4 and performing adjustment to lower the input impedance of the switcher 4, the voltage applied to the switcher 4 can be lowered.

In this way, according to this embodiment, the tunable antenna 400 includes the impedance adjuster 9 between the antenna element 3 and the switcher 4, thereby allowing reduction in the input impedance of the switcher 4. Therefore, a high voltage can be prevented from being applied to the switcher 4, thereby preventing degradation in characteristics or destruction of the electronic components constituting the switcher 4. Accordingly, a compact, high-performance tunable antenna 400 can be obtained.

In the disclosed tunable antenna in which the antenna element length is made variable by providing electronic components in the antenna element, the application of high voltage to the electronic components can be reduced.

The structures of the tunable antennas in some embodiments may be combined. For example, the designated connection position of the switcher 4 in Embodiment 1, the phase rotator 6 in Embodiment 2, the frequency selector 8 in Embodiment 3, and the impedance adjuster 9 in Embodiment 4 may be appropriately combined.

Although this disclosure is based on embodiments and the accompanying drawings, it is to be noted that various changes and modifications will be apparent to those skilled in the art based on this disclosure. Therefore, such changes and modifications are to be understood as included within the scope of this disclosure. For example, the functions and the like included in the various structural components may be reordered in any logically consistent way. Furthermore, structural components may be combined into one or divided.

1. A tunable antenna comprising:
an antenna element including a feed point at one end thereof, a feed line being connected to the feed point; and
a switcher configured to switch a resonance frequency of the antenna element;
wherein the switcher is connected to the antenna element at a position that is at a distance other than (λₘ/4)×n from the one end towards another end of the antenna element, where λₘ represents a wavelength corresponding to any resonance frequency of the antenna element, and n is a positive, odd number.

2. The tunable antenna of claim 1, wherein the switcher is connected to the antenna element at a position that is at a distance of less than λₘ/4 from the one end towards the other end of the antenna element, where λₘᵢₙ represents a smallest wavelength among wavelengths corresponding to all resonance frequencies of the antenna element.

3. A tunable antenna comprising:
an antenna element including a feed point at one end thereof, a feed line being connected to the feed point;
a switcher configured to switch a resonance frequency of the antenna element; and
a phase rotator connected between the antenna element and the switcher and configured to shift a phase of voltage applied to the switcher.

4. A tunable antenna comprising:
an antenna element including a feed point at one end thereof, a feed line being connected to the feed point;
a switcher configured to switch a resonance frequency of the antenna element; and
a frequency selector connected between the antenna element and the switcher and configured to allow passage of a signal at a predetermined frequency.

5. The tunable antenna of claim 4, wherein the frequency selector shifts a phase of voltage applied to the switcher.

6. A tunable antenna comprising:
an antenna element including a feed point at one end thereof, a feed line being connected to the feed point;
a switcher configured to switch a resonance frequency of the antenna element; and
an impedance adjustor connected between the antenna element and the switcher and configured to lower an input impedance of the switcher.
